(19) United States
(12) Patent Application Publication
(10) Pub. No.: US 2022/0259886 A1
(43) Pub. Date: Aug. 18, 2022

(54) Guard Device for Fencing

(71) Applicant: Matt Chase, Auburn, CA (US)

(72) Inventor: Matt Chase, Auburn, CA (US)

(21) Appl. No.: 17/669,478

(22) Filed: Feb. 11, 2022

Related U.S. Application Data
(60) Provisional application No. 63/149,461, filed on Feb. 15, 2021.

(51) Int. Cl. E04H 17/00; E04H 17/14; F21S 9/03; F21S 4/28

(52) U.S. Cl. CPC E04H 17/003; E04H 17/143; F21Y 2103/10; F21S 4/28; F21S 9/037

(57) ABSTRACT

The present invention relates to a novel guard or cap device for wooden, metal, vinyl, or composite fencings. The guard device is in the form of a metal or composite cap that is placed on the top of a plurality of fence pickets. More specifically, the guard device includes a cavity formed by two parallel panels which are connected at their respective top edges by a horizontal panel. The device protects the fence from rot, warping, and misalignment by covering or capping the tops of the plurality of fence pickets. Other embodiments of the guard device have a series of spikes for repelling birds and a solar panel for absorbing solar light and converting same into electric energy.

### CROSS-REFERENCE TO RELATED APPLICATION

The present application claims priority to, and the benefit of, U.S. Provisional Application No. 63/149,461, which was filed on Feb. 15, 2021 and is incorporated herein by reference in its entirety.

### FIELD OF THE INVENTION

The present invention relates generally to the field of wooden, composite or plastic fences. More specifically, the invention relates to a guard or cap device in the form of a modified metal sheet cap designed to be installed along the top of plank fences for eliminating dry rot, warping and misalignment, and to add an aesthetic and decorative value to the fence. The device prolongs the life and alignment of the fence and is available in various colors and designs. Accordingly, the present disclosure makes specific reference thereto. Nonetheless, it is to be appreciated that aspects of the present invention are also equally applicable to other like applications, devices and methods of manufacture.

### BACKGROUND

By way of background, wooden, composite, vinyl or plastic fence panels or pickets are commonly built, constructed and used for creating a stockade or privacy fence for homes, pools, yards, gardens and other areas. Often, wood fencing is made from cedar, pine or redwood. However, weather conditions affect the appearance and structural integrity of wood fences over time. More specifically, rot is a common fungal disease that affects fences made from wood and is caused due to the moisture in wood. Namely, wood rot or wet rot is caused by excessive exposure of wood to moisture, and especially when moisture levels in the wood reaches to more than 50 percent. Wet rot is a fungal species known as C. puteana or cellar fungus and can damage the top portions near the dog ears or top edges of the fencing panels, planks or boards.

Dry rot is caused by a species of fungus that thrives at lower moisture levels. Dry rot also causes a damp and musty smell and decolorizes the wood. Dry rot makes the fence panels and pickets weak and fragile, while also decolorizing or fading the fence. Individuals need to make extensive repairs to their fences or opt to completely replace the fence in order to get rid of both the wet rot and dry rot.

Wooden fencings also face the problem of warping and misalignment. Wood warping causes a deformity in wooden fencings that often results in bowing and misalignment that can result in unusable individual wooden boards, planks or pickets. Wood warping occurs when different parts of wood board experience changes in moisture content. Further, sealing and staining do not prevent wooden fencing from warping and may require a person to replace wooden boards or pickets. Individuals desire a way to protect wood warping of wooden fencing that eliminates deploying expensive warping correction methods.

Individuals generally replace the fence boards/pickets or repair them using mechanical fasteners for protecting against rot and warping. Other methods including polishing and painting the fence. However, these methods are not only expensive, but time consuming and require periodic maintenance.

Therefore, there exists a long felt need in the art for a system that can effectively prevent dry rot, wet rot, warping and misalignment of the fencing pickets and posts of, for example, a stockade or privacy fence. There is also a long felt need in the art for a device that maintains a quality wooden fence for a long period of time without periodic repair and replacement. Additionally, there is a long felt need in the art for a wooden fence guard system that eliminates expensive repair and replacement of wooden fencing posts and pickets. Moreover, there is a long felt need in the art for a device that prevents decolorizing or fading of stained wooden fencing. Further, there is a long felt need in the art for a wooden fence guard or cap device that can be easily installed on the wooden, composite or vinyl fencing. Finally, there is a long felt need in the art for a device and system that prolongs the life of, for example, a stockade or privacy fence by preventing rot and warping of the fence posts and pickets The guard device 100 provides impact resistance to hail, high winds and heavier snow loads, and also adds an aesthetic and decorative value to the fence.

The subject matter disclosed and claimed herein, in one embodiment thereof, comprises a rust proof guard or cap device for protecting a wooden fence from rot and warping, and also for protecting a composite or vinyl fence from warping and misalignment. The fence guard or cap device is designed to be installed on top of the fence pickets to prolong the life of the fence. The fence guard device is a linearly elongated metal or composite cap that includes a pair of parallel steel or composite panels, each panel can be rectangular and the panels can be connected to each other at their respective top edges with a horizontal flat steel or composite panel to form a cavity wherein the cavity is formed by the parallel panels and the horizontal panel and includes a bottom opening running along the length of the parallel panels and includes a pair of side openings. The fence guard or cap device is installed on top of the fence (i.e. top of the pickets) such that the flat panel rests on the top of the fence and further, the cap device includes a plurality of holes that are used for fastening the guard or cap device to the fence using stainless steel screws. The guard or cap device protects the wood fence from moisture and debris. Further, the top of the dog ears of the fence (i.e. the top of the pickets) is also protected by the guard or cap device.

In this manner, the rust proof guard or cap device of the present invention accomplishes all of the forgoing objectives and provides users with a metal or composite cap designed to be installed along the top of the wooden plank fences (i.e. fence pickets) for preventing dry rot, wet rot, misalignment and warping for prolonging the life of the fence. The device is easy to install and maintains a quality fence for a long period of time without periodic maintenance and repair.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rust proof guard or cap device for protecting a wooden fence from rot and warping, and also for protecting a composite or vinyl fence from warping and misalignment. The fence guard or cap device is designed to be installed on top of the fence pickets to prolong the life of the fence. The fence guard device is a linearly elongated metal or composite cap that includes a pair of parallel steel or composite panels, each panel can be rectangular and the panels can be connected to each other at their respective top edges with a horizontal flat steel or composite panel to form a cavity, wherein the cavity is formed by the parallel panels and the horizontal panel and includes a bottom opening running along the length of the parallel panels and includes a pair of side openings. The fence guard or cap device is installed on top of the fence (i.e. top of the pickets) such that the flat panel rests on the top of the fence and further, the cap device includes a plurality of holes that are used for fastening the guard or cap device to the fence using stainless steel screws. The guard or cap device protects the wood fence from moisture and debris. Further, the top of the dog ears of the fence (i.e. the top of the pickets) is also protected by the guard or cap device.

In yet another embodiment, the fence guard or cap device is a composite material or metal material constructed using 24- or 26-gauge steel.

In yet another embodiment, the fence guard or cap device includes a Kynar coating for providing mechanical strength and glossiness to the fence guard or cap device.

In yet another embodiment, the fence guard is about eight to ten feet in length and about two inches in height.

In yet another embodiment, each panel includes a thickness in the range from about 4 mm to about 10 mm.

In yet another embodiment, a method of protecting wooden fencing from dry rot and warping is disclosed. The method includes the steps of providing a fence guard or cap device, wherein the fence guard device is in the form of an elongated metal or composite cap having three panels forming a continuous cavity, placing the fence guard or cap device on top of the wooden fencing with the top of the wooden fencing inserted into the cavity and fastening the fence guard or cap device to the fence using a plurality of fasteners.

In yet another embodiment, the fasteners are stainless-steel fasteners.

In yet another embodiment, a guard or cap device for dog ears board fence (i.e. fence pickets) is disclosed. The fence guard device is in the form of a linearly elongated metal or composite cap having a pair of parallel stainless-steel or composite panels, each stainless-steel or composite panel is rectangular and the panels are connected to each other at their top edges with a horizontal flat stainless-steel or composite panel to form a cavity wherein the cavity is formed by the parallel panels and the horizontal panel in the form of a continuous opening for installing on top of the fence. The exterior surface of the horizontal flat panel can include spikes along the length of the device for repelling birds and preventing birds from perching on the device.

In yet another embodiment, a plurality of individual guard or cap devices can be stacked side by side, or mounted end to end for protecting a long fence.

In yet another embodiment, the guard or cap device extends to the bottom cut of the dog ears on standard fence boards or fence pickets.

In yet another embodiment, the guard or cap device may be manufactured in a plurality of colors and designs.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fencing guard or cap device of the present invention in accordance with the disclosed architecture;

FIG. 2 illustrates a perspective view showing a wooden fence equipped with the guard or cap device of the present invention in accordance with the disclosed architecture;

FIG. 3 illustrates a partial perspective view showing two fence guard or cap devices stacked or aligned together in accordance with the disclosed architecture;

FIG. 4 illustrates a perspective view of another potential embodiment of the fencing guard or cap device of the present invention in accordance with the disclosed architecture; and

FIG. 5 illustrates a perspective view showing yet another embodiment of the fencing guard or cap device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a system that can effectively prevent dry rot, wet rot, warping and misalignment of the fencing pickets and posts of, for example, a stockade or privacy fence. There is also a long felt need in the art for a device that maintains a quality wooden fence for a long period of time without periodic repair and replacement. Additionally, there is a long felt need in the art for a wooden fence guard system that eliminates expensive repair and replacement of wooden fencing posts and pickets. Moreover, there is a long felt need in the art for a device that prevents decolorizing or fading of stained wooden fencing. Further, there is a long felt need in the art for a wooden fence guard or cap device that can be easily installed on the wooden, composite, or vinyl fencing. Finally, there is a long felt need in the art for a device and system that prolongs the life of, for example, a stockade or privacy fence by preventing rot and warping of the fence posts and pickets.

The present invention, in one exemplary embodiment, is a novel guard or cap device for dog ears board or picket fencing. The fence guard device is in the form of a linearly elongated metal or composite cap having a pair of parallel stainless-steel or composite panels, each stainless-steel or composite panel is rectangular and the panels are connected to one another at their respective top edges with a horizontal flat stainless-steel or composite panel to form a cavity, wherein the cavity is formed by the parallel panels and the horizontal panel in the form of a continuous opening for installing on top of the fence. The exterior surface of the horizontal flat panel, in one exemplary arrangement, includes spikes along the length of the device for repelling birds and preventing birds from sitting or perching on the device.

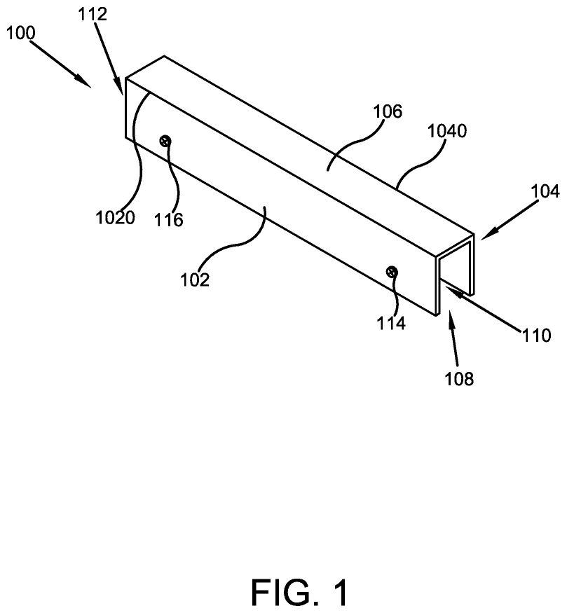

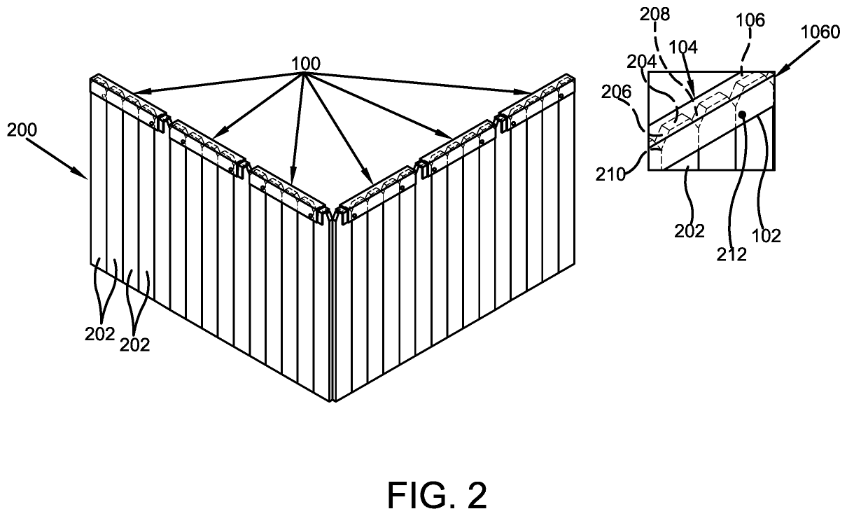

Referring initially to the drawings, FIG. 1 illustrates a perspective view of one potential embodiment of the fencing guard or cap device of the present invention in accordance with the disclosed architecture. The fencing guard or cap device 100 is designed to be installed on top of, for example, a wooden fence as illustrated in FIG. 2. More specifically, the device 100 can be a rigid cap constructed from 24-gauge or 26-gauge stainless steel or a rust proof and lightweight metal such as aluminum, or a composite material. The device 100 can comprise a one-piece molded structure having a first vertical rectangular panel 102 and a second vertical rectangular panel 104, the second vertical rectangular panel 104 is positioned parallel to the first vertical rectangular panel 102. A flat horizontal panel 106 connects the top edge 1020 of the first vertical rectangular panel 102 and the top edge 1040 of the second vertical rectangular panel 104.

The panels 102, 104, 106 form a bottom cavity space 108, a first side opening 110 and a second side opening 112. The guard or cap device 100 is placed on the top of a wooden fence by snapping the device 100 down over through the bottom cavity space 108 with the top of the wooden fencing touching the inner surface of the flat horizontal panel 106 as shown in FIG. 2. The first vertical rectangular panel 102 includes a pair of holes 114, 116 that are used for fastening the device 100 to a wooden fence using mechanical fasteners such as stainless-steel screws. The length of each panel 102, 104, 106 can be in the range from about 8 feet to about 10 feet, for example, and the width can be in the range from about 3 inches to about 9 inches, for example. Each panel can include a polyvinylidene fluoride (PVDF) coating/finish, or Kynar® coating/finish, which is a pure thermoplastic fluoropolymer that is non-reactive and possesses multiple coating benefits. The MIN' coating/finish is unaffected by most chemicals and solvents and has excellent wear and abrasion resistance. The PVDF finish increases durability and glossiness of the device 100. The PVDF coating/finish used in the present invention provides high dielectric strength and excellent resistance to weathering elements in harsh environments. The guard device 100 provides impact resistance to hail, high winds and heavier snow loads, and also adds an aesthetic and decorative value to the fence.

FIG. 2 illustrates a perspective view showing a wooden fence equipped with the guard or cap device of the present invention in accordance with the disclosed architecture. As shown, the wooden fencing 200 is formed of a plurality of stacked dog eared wooden boards, or fence pickets, shown exemplary through numerals 202. Each dog ear wooden board or picket 202 can include a top surface or top edge 204 and a pair of dog ears 206, 208. The guard or cap device 100 is placed on the top of the fence 200 such that the inner surface 1060 of the horizontal surface 106 rests on the top surface or top edge 204 of each wooden board 202. The parallel panels 102, 104 cover the wooden fencing from opposing sides and extends to at least the bottom cut 210 of the dog ears 206, 208 (i.e. extends to at least a height of the dog ears). The device described supra provides a stable and safe positioning of the device 100 on the wooden fencing 200. Further, the device 100 is fastened to the wooden fencing 200 using stainless-steel screws 212 inserted into the holes positioned on the parallel planes 102, 104.

For covering a long fence, a plurality of guard or cap devices can be stacked side-by-side or end-to-end for covering the top surface of the fence boards or pickets throughout the length of the fence 200. Individual devices can be separately pulled out for repair and replacement purposes without affecting other deployed guard or cap devices.

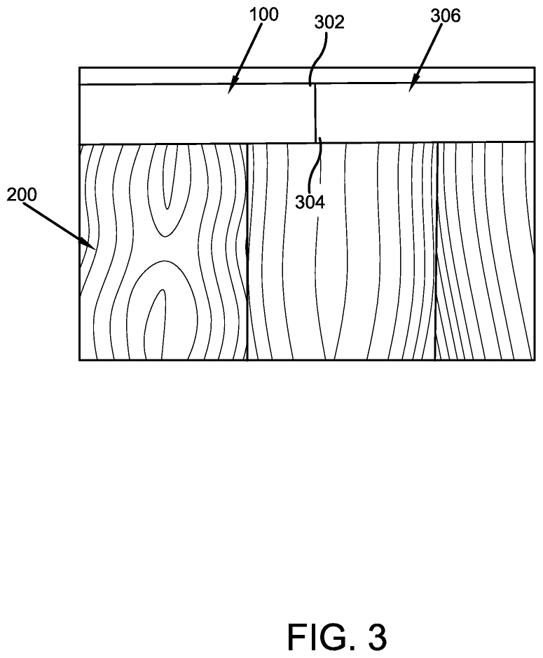

FIG. 3 illustrates a partial perspective view showing two fence guard or cap devices stacked together in accordance with the disclosed architecture. As shown, for protecting the wooden fencing 200, the fence guard or cap devices 100 are stacked such that a first end 302 of the first guard or cap device 100 is stacked to, or aligned with, the second end 304 of the second guard or cap device 306. It should be noted that the first guard or cap device 100 and the second guard 306 are essentially having same shape, size and material.

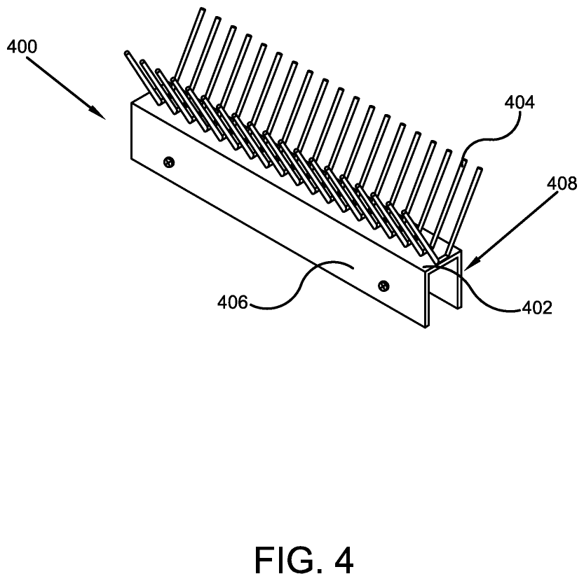

FIG. 4 illustrates a perspective view of another potential embodiment of the wooden fencing guard device of the present invention in accordance with the disclosed architecture. The device 400 of the present invention can be constructed from 24-gauge or 26-gauge stainless steel or a rust proof and lightweight metal such as aluminum. The device 400 can include the same structure and configuration as of the device 100 described in FIG. 1. However, the device 400 of the present embodiment includes a series of spikes 404 on the top surface 402 for repelling birds and preventing the birds from sitting or perching on the device 400. The spikes 404 can be made from steel or a metal.

The structure having three panels 402, 406, 408 with a cavity therebetween is similar to the device 100 of FIG. 1. Further, the device 400 can be placed on the top of a fence to protect the fence while deterring birds from to sit on or perching on the structure 400.

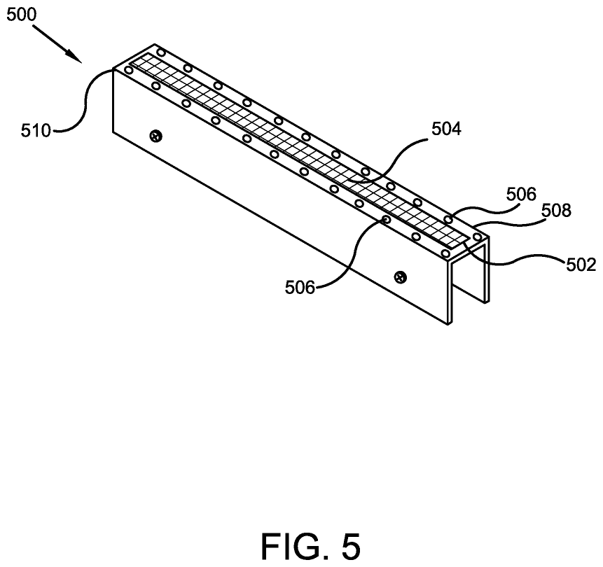

FIG. 5 illustrates a perspective view showing yet another embodiment of the wooden fencing guard device of the present invention in accordance with the disclosed architecture. The device 500 is designed as a metal or composite cap similar to the devices of other embodiments of the present invention and is configured to place on top of the fence with the device 500 in a secure engagement position with the wooden fencing.

In the present embodiment, the top surface 502 includes a weatherproof solar panel 504 configured to absorb solar energy and convert it into electric energy. The electric energy produced by the solar panel 504 is provided to the LED strips 506 positioned along the edges 508,510. The LED strips 506 are illuminated in a plurality of colors using the electric energy. The present embodiment is especially useful to indicate the periphery while viewing the device 500 during night and low light. Also, the fencing cap/guard device 100, 400, 500 as shown in the FIGS. can be manufactured to cap the top of any wood fence, and is not limited to a specific single width fence board.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “guard or cap device”, “guard device for wooden fencing”, “device” and “wooden fencing guard device” are interchangeable and refer to the fencing guard device 100,400,500 of the present invention.

Notwithstanding the forgoing, the fencing cap/guard device 100, 400, 500 of the present invention can be of any suitable size and configuration as is known in the art without affecting the overall concept of the invention, provided that it accomplishes the above-stated objectives. One of ordinary skill in the art will appreciate that the fencing cap/guard device 100, 400, 500 as shown in the FIGS. are for illustrative purposes only, and that many other sizes and shapes of the fencing cap/guard device 100, 400, 500 are well within the scope of the present disclosure. Although the dimensions of the fencing cap/guard device 100, 400, 500 are important design parameters for user convenience, the fencing cap/guard device 100, 400, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fencing guard cap device comprising:
a rigid cap including a first vertical panel, a second vertical panel, and a horizontal panel connecting an upper edge of said first vertical panel and an upper edge of said second vertical panel thereby forming a cavity thereunder;
wherein said first vertical panel is parallel to said second vertical panel;
wherein said cavity includes a first side opening and a second side opening; and
further wherein said cavity, said first side opening, and said second side opening receives top sections of a plurality of fence pickets.

2. The fencing cap device of claim 1, wherein said rigid cap includes a material selected from a group consisting of a 24-gauge stainless steel, a 26-gauge stainless steel, an aluminum, and a composite material.

3. The fencing cap device of claim 1, wherein said rigid cap is a one-piece molded structure.

4. The fencing cap device of claim 1, wherein at least one of said first vertical panel and said second vertical panel include at least two holes and each said hole receives a fastener therethrough to secure said rigid cap to said plurality of fence pickets.

5. The fencing cap device of claim 1, wherein an inner surface of said horizontal panel rests on a top edge of said plurality of fence pickets.

6. The fencing cap device of claim 1, wherein said fastener is a stainless-steel screw.

7. The fencing cap device of claim 1, wherein said rigid cap includes a length in the range from about 8 feet to about 10 feet.

8. The fencing cap device of claim 7, wherein said rigid cap includes a width in the range from about 3 inches to about 9 inches.

9. The fencing cap device of claim 8, wherein said rigid cap includes an exterior coating of pure thermoplastic fluoropolymer.

10. The fencing cap device of claim 9, wherein said exterior coating is a PVDF coating.

11. The fencing cap device of claim 8, wherein each said plurality of fence pickets include a pair of dog ears extending downwards from opposing sides of said top edge, wherein said dog ears include a height, and further wherein said width of said rigid cap is greater than said height of said dog ears.

12. The fencing cap device of claim 11, further comprising a plurality of said rigid caps mounted end-to-end for covering a designated length of fencing.

13. The fencing cap device of claim 1, wherein an outer surface of said horizontal panel includes a plurality of spikes extending therefrom.

14. The fencing cap device of claim 1, wherein an outer surface of said horizontal panel includes a solar panel and an LED strip, and further wherein said solar panel converts solar energy into electric energy for powering said LED strip.

15. A fencing guard cap device comprising:
a rigid cap including a first vertical panel, a second vertical panel, and a horizontal panel connecting an upper edge of said first vertical panel and an upper edge of said second vertical panel thereby forming a cavity thereunder;
wherein said first vertical panel is parallel to said second vertical panel;
wherein said cavity includes a first side opening and a second side opening;
wherein said cavity, said first side opening, and said second side opening receives top sections of a plurality of fence pickets;
wherein at least one of said first vertical panel and said second vertical panel include at least one hole for receiving a fastener therethrough to secure said rigid cap to said plurality of fence pickets;
wherein an inner surface of said horizontal panel rests on a top edge of said plurality of fence pickets;
wherein said rigid cap includes a length in the range from about 8 feet to about 10 feet;
wherein said rigid cap includes a width in the range from about 3 inches to about 9 inches; and
a plurality of said rigid caps mounted end-to-end for covering a designated length of fencing.

16. The fencing cap device of claim 15, wherein an outer surface of said horizontal panel includes a solar panel and an LED strip, and further wherein said solar panel converts solar energy into electric energy for powering said LED strip.

17. The fencing cap device of claim 15, wherein an outer surface of said horizontal panel includes a plurality of spikes extending therefrom.

18. A fencing guard cap device comprising:
a rigid cap including a first vertical panel, a second vertical panel, and a horizontal panel connecting an upper edge of said first vertical panel and an upper edge of said second vertical panel thereby forming a cavity thereunder;
wherein said first vertical panel is parallel to said second vertical panel;
wherein said cavity includes a first side opening and a second side opening;
wherein said cavity, said first side opening, and said second side opening receives top sections of a plurality of fence pickets;
wherein at least one of said first vertical panel and said second vertical panel include at least one hole for receiving a fastener therethrough to secure said rigid cap to said plurality of fence pickets;
wherein an inner surface of said horizontal panel rests on a top edge of said plurality of fence pickets;
wherein said rigid cap includes a width in the range from about 3 inches to about 9 inches;
wherein each said plurality of fence pickets include a pair of dog ears extending downwards from opposing sides of said top edge;
wherein said dog ears include a height; and
further wherein said width of said rigid cap is greater than said height of said dog ears.

19. The fencing cap device of claim 18, wherein an outer surface of said horizontal panel includes a plurality of spikes extending therefrom.

20. The fencing cap device of claim 18, wherein an outer surface of said horizontal panel includes a solar panel and an LED strip, and further wherein said solar panel converts solar energy into electric energy for powering said LED strip.
